(19) United States
(12) Patent Application Publication
(10) Pub. No.: US 2015/0291054 A1
(43) Pub. Date: Oct. 15, 2015

(54) Traction Battery Air Thermal Management Control System

(71) Applicant: Ford Global Technologies, LLC, Dearborn, MI (US)

(72) Inventors: Xiaohong Nina Duan, Canton, MI (US); Chuan He, Northville, MI (US)

(73) Assignee: Ford Global Technologies, LLC, Dearborn, MI (US)

(21) Appl. No.: 14/253,076

(22) Filed: Apr. 15, 2014

(51) Int. Cl. B60L 11/18; B60K 1/04

(52) U.S. Cl. CPC B60L 11/1874; B60K 1/04; H01M 10/6563; H01M 10/625; H01M 2220/20

(57) ABSTRACT

A vehicle traction battery system may include a battery pack, a fan configured to direct air flow to the pack, and a controller. The controller may be programmed to, in response to a predicted pack temperature being greater than a first predefined temperature, direct the fan to operate at a predefined generally constant speed that does not change with vehicle speed or engine on/off state until the predicted battery pack temperature falls below a second predefined temperature. A method is also provided for cooling the vehicle traction battery system based on a predicted battery pack temperature and a heat generation rate.

### TECHNICAL FIELD

This disclosure relates to thermal management systems for propulsion batteries utilized in vehicles.

### BACKGROUND

Vehicles such as battery-electric vehicles (BEVs), plug-in hybrid-electric vehicles (PHEVs), mild hybrid-electric vehicles (MHEVs), or full hybrid-electric vehicles (FHEVs) contain a traction battery, such as a high voltage (HV) battery, to act as a propulsion source for the vehicle. The HV battery may include components and systems to assist in managing vehicle performance and operations. The HV battery may include one or more arrays of battery cells interconnected electrically between battery cell terminals and interconnector busbars. The HV battery and surrounding environment may include a thermal management system to assist in managing temperature of the HV battery components, systems, and individual battery cells.

Vehicles with one or more HV batteries may include a battery management system that estimates values descriptive of a HV battery and/or battery cell present operating conditions. The HV battery and/or battery cell operating conditions may include, for example, battery SOC, power fade, capacity fade, and instantaneous available power. The battery management system may be capable of estimating values during changing battery cell characteristics as the battery cell ages over the lifetime of the HV battery. The precise estimation of some parameters may improve performance and robustness, and may ultimately lengthen the useful lifetime of the HV battery.

### SUMMARY

A method for cooling a traction battery system of a vehicle includes, in response to a predicted battery pack temperature being greater than a predefined threshold, adjusting by controller a speed of a battery cooling fan according to a battery heat generation rate such that for a given battery heat generation rate, the speed remains generally constant as a speed of the vehicle changes and a stop/start state of an engine changes. In response to the predicted battery pack temperature being less than another predefined threshold, the controller may adjust the speed of the battery cooling fan according to the speed of the vehicle or a stop/start state of the engine. In response to the predicted battery pack temperature being less than another predefined threshold, the controller may adjust the speed of the battery cooling fan according to the battery heat generation rate, the speed of the vehicle, and the on/off state of the engine. The predefined threshold and the another predefined threshold may be equal to one another. The predefined threshold may be a predefined temperature of the battery pack in which the battery pack is configured to cease operation or reduce power input/output when reached. The heat generation rate may be based on a difference between energy delivered to and removed from the system and a change in internal energy of the system. The speed of the battery cooling fan may be adjusted such that a temperature of the battery pack is maintained below the predefined threshold

A vehicle includes a motor, a traction battery pack configured to supply power to the motor, a fan configured to direct air flow to the traction battery pack, and at least one controller. The controller is programmed to, in order to maintain a temperature of the traction battery pack below a predefined pack cutoff temperature, (i) set a speed of the fan based on a heat generation rate of the traction battery pack, in response to a predicted temperature of the traction battery pack exceeding a first predefined value, such that for a given heat generation rate, the speed remains generally constant as a speed of the vehicle changes and an on/off state of an engine changes, and (ii) set the speed of the fan based on the speed of the vehicle or the on/off state of the engine in response to the predicted temperature falling below a second predefined value. The first predefined value may be a temperature equal to or less than the predefined pack cutoff temperature. The first and second predefined values may be equal to one another. In response to the predicted temperature falling below the second predefined value, the speed of the fan may be set further based on the heat generation of the traction battery pack. The heat generation rate may be based on a difference between energy delivered to and removed from the traction battery pack, an amount of heat leaving the traction battery pack, and a change in internal energy of the traction battery pack.

A vehicle traction battery system includes a battery pack, a fan configured to direct air flow to the pack, and at least one controller. The controller is programmed to, in response to a predicted pack temperature being greater than a first predefined temperature, direct the fan to operate at a predefined generally constant speed that does not change with vehicle speed or engine on/off state until the predicted battery pack temperature falls below a second predefined temperature. The predicted pack temperature may be based on a heat generation rate of the pack. The heat generation rate may be based on a heat capacity of the pack and a change in temperature of the pack over time. The heat generation rate may be based on a battery pack voltage, a battery pack open circuit voltage, a battery pack current flow, a battery pack heat transfer coefficient, a battery pack temperature, and a temperature of air within a battery pack fan inlet duct. The first predefined temperature may be a temperature at which the pack is configured to cease operating when reached. The first predefined temperature may be a temperature at which the pack is configured to reduce power input/output.

### BRIEF DESCRIPTION OF THE DRAWINGS

FIG. 1 is a schematic illustration of a battery electric vehicle.

FIG. 2 is a perspective view of a portion of a thermal management system for the traction battery of the vehicle in FIG. 1.

FIG. 3A is a graph illustrating a battery pack temperature plot over a period of time.

FIG. 3B is a graph illustrating a fan speed plot of a thermal management system for the battery pack of FIG. 3A over a period of time.

FIG. 3C is a graph illustrating a vehicle speed plot from the vehicle including the battery pack from FIG. 3A over a period of time.

FIG. 4 is a block diagram illustrating an example of battery electric vehicle with an air thermal management system.

FIG. 5 is a flow chart illustrating an algorithm for operation of a thermal management control system for the vehicle of FIG. 4.

FIG. 6A is a graph illustrating a comparison between two battery pack temperature plots of two thermal management control systems.

FIG. 6B is a graph illustrating a comparison between two fan speed plots of the two thermal management control systems from FIG. 6A.

FIG. 6C is a graph illustrating a vehicle speed plot for use by the two thermal management control systems of FIG. 6A.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

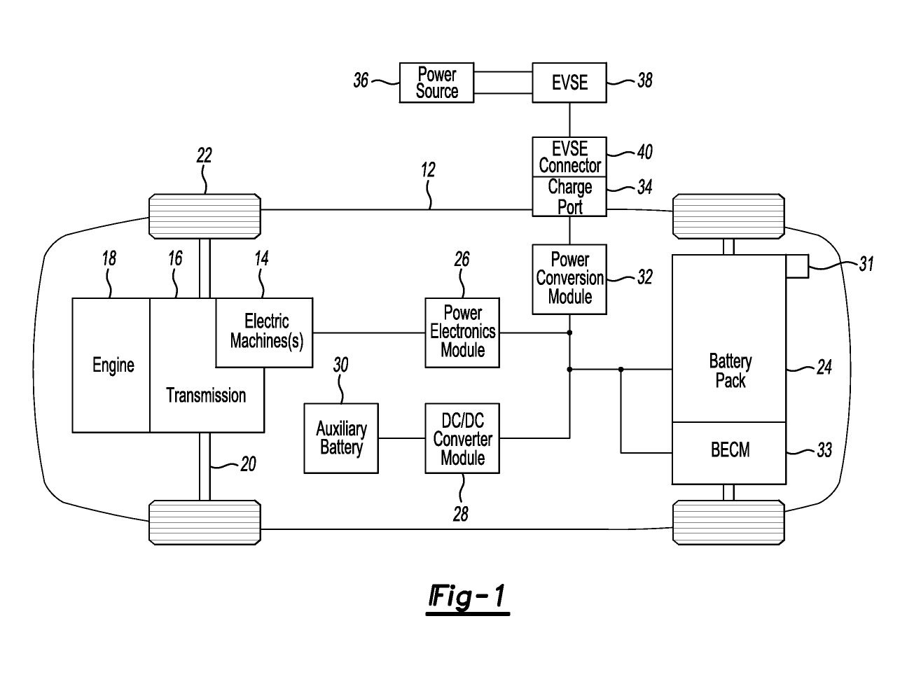

FIG. 1 depicts a schematic of a typical plug-in hybrid-electric vehicle (PHEV). A typical plug-in hybrid-electric vehicle 12 may comprise one or more electric machines 14 mechanically connected to a hybrid transmission 16. The electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy that would normally be lost as heat in the friction braking system. The electric machines 14 may also provide reduced pollutant emissions since the hybrid-electric vehicle 12 may be operated in electric mode under certain conditions.

A traction battery or battery pack 24 stores energy that can be used by the electric machines 14. The traction battery 24 typically provides a high voltage DC output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors isolate the traction battery 24 from other components when opened and connect the traction battery 24 to other components when closed. The power electronics module 26 is also electrically connected to the electric machines 14 and provides the ability to bi-directionally transfer electrical energy between the traction battery 24 and the electric machines 14. For example, a typical traction battery 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In a typical vehicle, the low-voltage systems are electrically connected to an auxiliary battery 30 (e.g., 12V battery).

A battery electrical control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be, for example, an electric vehicle such as a plug-in hybrid vehicle, or a battery-electric vehicle in which the traction battery 24 may be recharged by an external power source 36. The external power source 36 may be a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via discrete conductors.

The battery cells, such as a prismatic cell, may include electrochemical cells that convert stored chemical energy to electrical energy. Prismatic cells may include a housing, a positive electrode (cathode) and a negative electrode (anode). An electrolyte may allow ions to move between the anode and cathode during discharge, and then return during recharge. Terminals may allow current to flow out of the cell for use by the vehicle. When positioned in an array with multiple battery cells, the terminals of each battery cell may be aligned with opposing terminals (positive and negative) adjacent to one another and a busbar may assist in facilitating a series connection between the multiple battery cells. The battery cells may also be arranged in parallel such that similar terminals (positive and positive or negative and negative) are adjacent to one another. For example, two battery cells may be arranged with positive terminals adjacent to one another, and the next two cells may be arranged with negative terminals adjacent to one another. In this example, the busbar may contact terminals of all four cells.

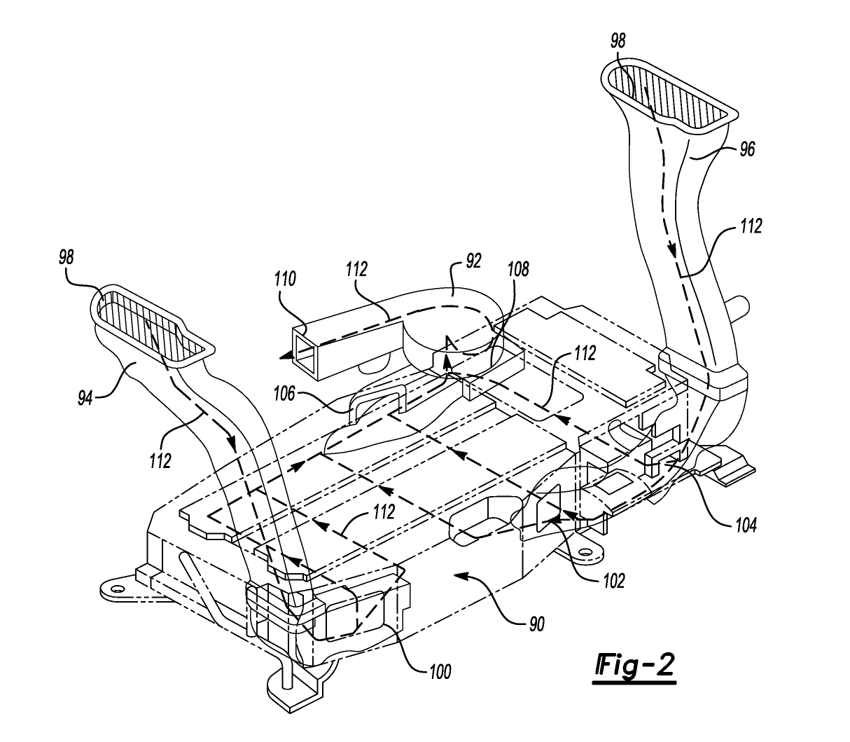

The traction battery 24 may be heated and/or cooled using an air thermal management system, or other method as known in the art. FIG. 2 shows one example of a portion of an air thermal management system. A battery pack housing 90 (shown in phantom for illustrative purposes) may contain the traction battery 24 (not shown in this view) and other vehicle components proximate thereto, such as the DC/DC converter module 28 (not shown in this view) and BECM 33 (not shown in this view). The air thermal management system may include a blower unit 92, a first duct system 94, a second duct system 96, and one or more vents 98. Additional examples of the blower unit 92 may include a fan unit and/or an air pump. Battery pack housing inlet ports 100 and 102 may open to the first duct system 94 and the second duct system 96 to facilitate fluid communication with the traction battery 24. The vents 98 may serve as inlet ports to the first duct system 94 and the second duct system 96. As such, the vents 98 may assist in facilitating fluid communication between a vehicle cabin climate system, and the first duct system 94 and second duct system 96. The second duct system 96 may also be in fluid communication with the DC/DC converter module 28 via a DC/DC converter inlet port 104.

The blower unit 92 may be positioned downstream of the traction battery 24 and the DC/DC converter module 28. Further, the blower unit 92 may be positioned proximate to a battery pack housing outlet 106 and DC/DC converter module outlet 108 such that when the blower unit 92 is activated in a first direction, air is pulled across the traction battery 24, the DC/DC converter module 28, and out a blower outlet port and/or exhaust port 110. It is contemplated that the blower unit 92 may also be positioned upstream of the traction battery 24 and the DC/DC converter module 28. The outlet ports herein may also be referred to as exhaust ports. Due to fluid communication with the blower unit 92, the exhaust port 110 may also operate as an exhaust port for air used to cool the components within the battery pack housing 90. Dashed lines and reference arrows 112 show an example of the air flow entering the duct systems from the vehicle cabin via the vents 98, traveling through the duct systems and battery pack housing 90, and traveling through the blower unit 92 and exiting the blower exhaust port 110. The lines and reference arrows 112 are non-limiting examples of air flow.

Different battery pack configurations may be available to address individual vehicle variables including packaging constraints and power requirements. The traction battery 24 may be positioned at several different locations including below a front seat, below a rear seat, or behind the rear seat of the vehicle, for example. However, it is contemplated the traction battery 24 may be positioned at any suitable location in the vehicle 12.

A temperature of the traction battery 24 is a parameter that may influence vehicle performance, battery cell life, and allowed power charge and discharge of the traction battery 24. In certain FHEVs and MHEVs using an air thermal management system, the blower unit 92 may be operated in response to conditions such as the traction battery 24 temperature, vehicle speed, and/or engine on/off conditions. For example, a speed of the blower unit 92 may increase and/or decrease in response to vehicle speed thresholds. However, increased blower unit 92 speeds may also generate noise, vibration, and harshness (“NVH”) concerns which may be undesirable under certain operating conditions such as when the vehicle 12 operates at lower speeds during braking, deceleration, and both engine on and off conditions.

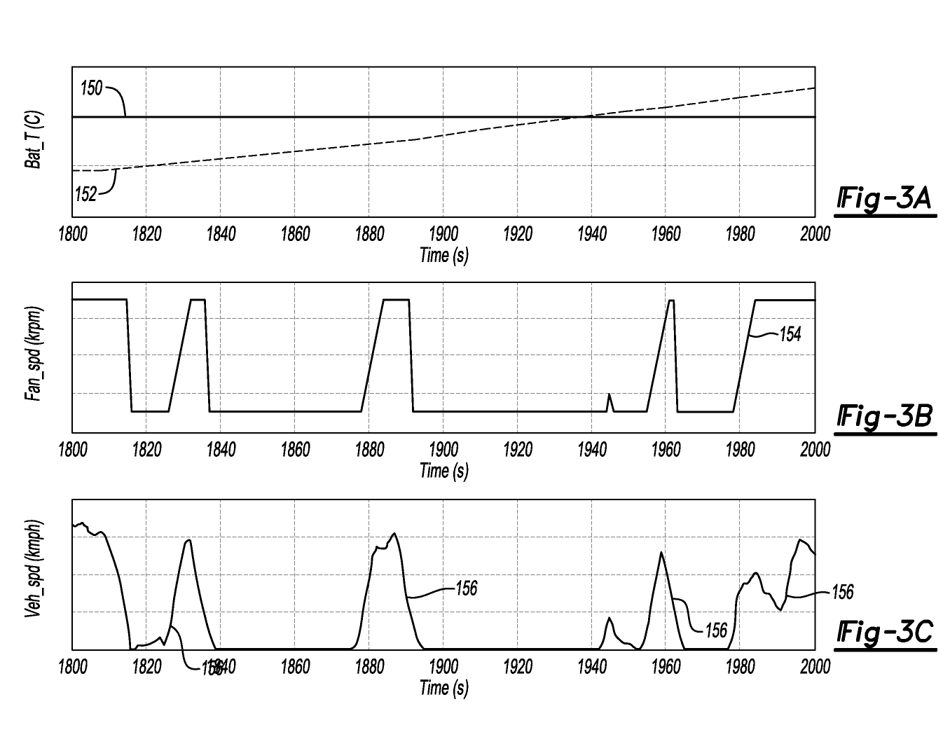

FIGS. 3A through 3B are graphs showing an example of a scenario in which a thermal management control system directs operation of a fan output in response to vehicle speed over time as represented by an x-axis. In FIG. 3A, a y-axis represents a battery pack temperature. In this scenario, a max temperature 150 represents a predefined battery temperature to trigger cutoff for power to the battery pack such that the battery pack ceases operation or lowers a power level output of the battery pack. A battery pack temperature 152 represents an actual temperature of the battery pack measured during vehicle operation. In FIG. 3B, a y-axis represents fan speed. A fan speed 154 represents an actual fan speed measured during operation of the vehicle. In FIG. 3C, a y-axis represents vehicle speed. An actual vehicle speed 156 is measured during vehicle operation.

Referring now to the time period between 1880 seconds and 1900 seconds, the battery pack temperature 152 is increasing and approaching the max temperature 150. However, vehicle speed 156 is shown decreasing which may be, for example, in response to an application of a braking system. Since the fan speed 154 is operating in response to vehicle speed 156, the fan speed 154 accordingly decreases and as a result, any cooling benefit to the battery pack temperature 152 from the fan is reduced and the battery pack temperature 152 continues to increase and exceed the max temperature 150. Reaching and/or exceeding the max temperature 150 may trigger the battery pack to shut off which may affect vehicle performance. At least two factors may contribute to this scenario: (i) the operating control of the fan speed depends on battery pack temperature as reported by real time temperature sensors and does not consider a projected and/or predicted battery pack temperature which may cause a delay in reacting to battery pack temperature changes, and (ii) due to fan NVH considerations, the fan speed is associated with the vehicle speed and does not take into account the max temperature 150 battery pack shut off. However, these factors may be overcome by adjusting the control system strategy to incorporate projected and/or predicted battery pack temperature based on a battery pack heat generation rate.

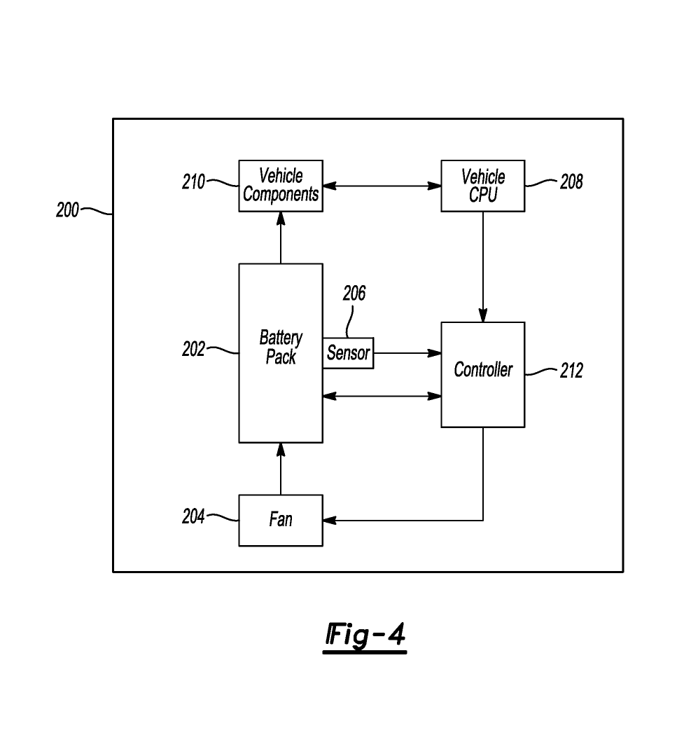

For example, FIG. 4 shows a vehicle 200 which may include a thermal management system for a battery pack 202. The thermal management system may be an air system which uses a fan 204 to direct air flow to the battery pack 202 to assist in managing the thermal conditions of the battery pack 202. A temperature sensor 206 may be in communication with the battery pack 202 to measure actual temperature thereof. A vehicle computer processing unit (“CPU”) 208 may be in communication with a plurality of vehicle components 210 such that the vehicle CPU 208 may receive information regarding the vehicle components 210 and also direct operation thereof. Examples of the vehicle components 210 may include an engine, a motor, a transmission, electric machines, and sensors to determine a vehicle speed. A controller 212 may be in communication with the vehicle CPU 208 and the temperature sensor 206 to receive information relating to the vehicle components 210 and a temperature of the battery pack 202. The controller 212 may also be in communication with the fan 204 to direct operation thereof.

A predicted battery temperature of the battery pack 202 may be calculated by examining a change rate of a filtered battery pack temperature of the battery pack 202 and/or by calculating the battery pack heat generation rate of the battery pack 202. When measuring the battery pack temperature, the temperature sensor 206 may also be exposed to high frequency noise from, for example, the vehicle components 210 which may be located proximate to the temperature sensor 206. As such, a signal from the temperature sensor 206 may be filtered through a low pass filter to separate the high frequency noise and to thus obtain the filtered battery pack temperature which may be used to calculate the predicted battery pack temperature. Since the change of battery pack temperature is proportional to pack heat energy change within the battery pack, the predicted battery pack temperature change may be estimated by examining the battery heat generation accumulated inside the pack and within a present time sliding window for the battery pack 202. For example and based on an energy balance of the thermal management system for the battery pack 202, the battery pack heat generation kept inside the pack may be based on a difference between an electric energy input and an output of the battery cells within the battery pack 202, an internal electric energy change, and a difference between heat in and heat out of the pack. This calculation may be expressed as

Battery Pack Heat Generation=(Electric Energy in−Electric Energy out)−(Internal Electrical Energy Change)+(Heat in−Heat out)

Here, Battery Pack Heat Generation is defined as battery pack heat generated inside the pack due to electrical ion flow resistances and chemical reactions which may be the energy that causes the battery pack temperature to change.

The total of heat generated by operation of the battery pack 202 may be expressed as:

(Electric Energy in−Electric Energy out)−Internal Electrical Energy Change=∫ₜ^{t+Δt}(V−OCV)Idt

In this expression, V equals a battery pack voltage, OCV equals a battery pack open circuit voltage, I equals a battery pack current, and t equals time.

A total heat generated and transferred by operation of the battery pack 202 may also be expressed as:

(Heat out−Heat in)+Pack Thermal Energy Change

The difference between heat out and heat in of the battery pack 202 may be expressed as

(Heat out−Heat in)=∫ₜ^{t+Δt}h(T_{cell}−T_{fan inlet})dt

In this expression, h equals a battery pack heat transfer coefficient, T_{cell} equals a battery pack temperature, T_{fan inlet} equals a temperature of air within an inlet duct of the battery pack 202, and t equals time.

The Battery Pack Heat Generation may refer to the battery pack heat generation inside the pack which is the Pack Thermal Energy Change of the battery pack 202 and may be expressed as

Pack Thermal Energy Change=αΔT

In this expression, α equals a battery pack heat capacity and T is a battery pack temperature. Therefore, the battery pack temperature change of a given time period, Δt, may be expressed as:

$$Δ T = \frac{1}{α} {\int }_{t}^{t + Δ t} \{ ( V - O C V ) I - h ( {T}_{cell} - {T}_{fan inlet} ) \} d t$$

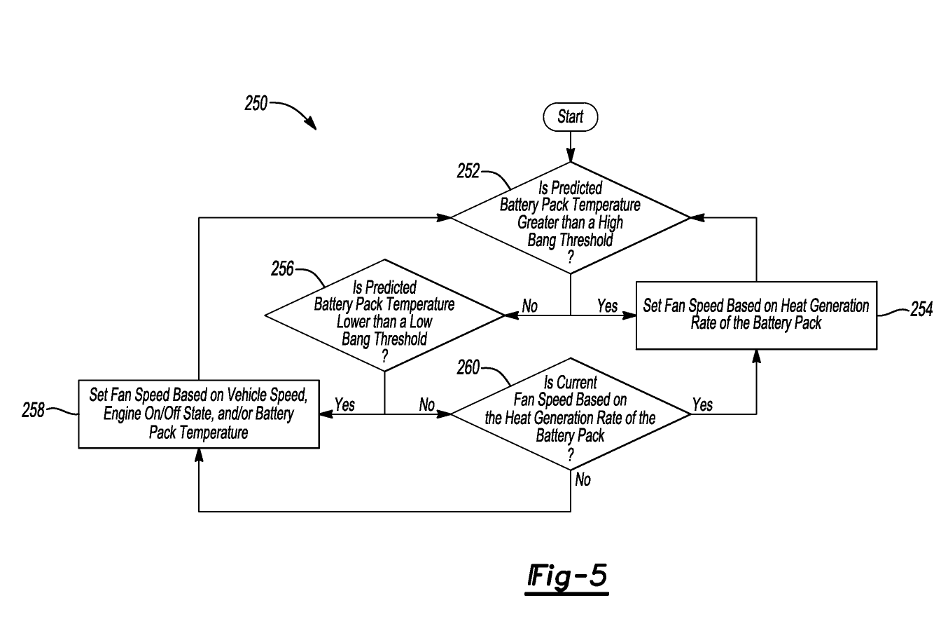

FIG. 5 shows an example of an algorithm for a thermal management control system. The algorithm is generally indicated by reference numeral 250. The controller 212 may include instructions relating to a predefined high bang temperature threshold and a predefined low bang temperature threshold. For example, the instructions may trigger one or more thermal management control system operations in response to the battery pack 202 temperature and/or predicted battery pack 202 temperature exceeding and/or falling below the high and low bang threshold temperatures. Operation 252 may include calculating a predicted battery pack 202 temperature change rate which may be expressed as

$$\frac{1}{α} [ ( V - O C V ) I - h ( {T}_{cell} - {T}_{fan inlet} ) ]$$

The controller 212 may receive information relating to the battery pack 202 voltage (V), the battery pack open circuit voltage (OCV), the battery pack 202 current (I), the battery pack 202 temperature (T_{cell}), and the temperature of air at the fan 204 (T_{fan inlet}). The controller 212 may then calculate a plot for the predicted battery pack 202 temperature over a given period of time. If the predicted battery pack 202 temperature is predicted to be greater than the predefined high bang threshold, the controller 212 may set the fan 204 speed based on the heat generation rate in operation 254. For example, the fan 204 speed may be set to a maximum level such that the fan 204 may provide increased air flow to the battery pack 202 to assist in preventing the battery pack 202 temperature from reaching the high bang threshold.

Optionally, the controller 212 may also execute weight functions during calculations relating to the predicted battery pack 202 temperature. A weight function is a mathematical device used when, for example, performing a sum, integral, or average to give some elements more “weight” or influence on the result than other elements in the same set. For example, the controller 212 may estimate the temperature of the battery pack 202 based on a time of occurrence of the heat generation rate calculated from data including I, OCV, V, T_{cell}, and T_{fan inlet}. The data which are more recent may be more relevant than older data and as such, the controller 212 assign a different value to the more recent data when integrating to calculate predicted battery pack 202 temperature and the heat generation rate of the battery pack 202.

In operation 256, the controller 212 may determine whether the predicted battery pack 202 temperature is lower than the low bang threshold. If the predicted battery pack 202 temperature is lower than the low bang threshold, the controller 212 may set the fan 204 speed based on heat generation and/or other conditions such as vehicle speed, engine or motor on/off state, and battery pack 202 temperature in operation 258. If the predicted battery pack 202 temperature is not lower than the low bang threshold in operation 256, the controller 212 may determine whether the current fan 204 speed is based on the heat generation rate of the battery pack 202 in operation 260, and then accordingly loop back to operation 254 or operation 258 based on the determination. As such, the thermal management control system of the battery pack 202 may, in response to the predicted battery pack 202 temperature being greater than the predefined high bang threshold, adjust the speed of the fan 204 according to the battery pack 202 heat generation rate such that for a given battery pack 202 heat generation rate, the fan 204 speed remains generally constant as a speed of the vehicle 200 changes. Further, the thermal management control system of the battery pack 202 may, in response to the predicted battery pack 202 temperature falling below a predefined high bang threshold, set the fan 204 speed based on the heat generation and/or battery pack 202 temperature and other conditions such as vehicle speed and engine on/off state.

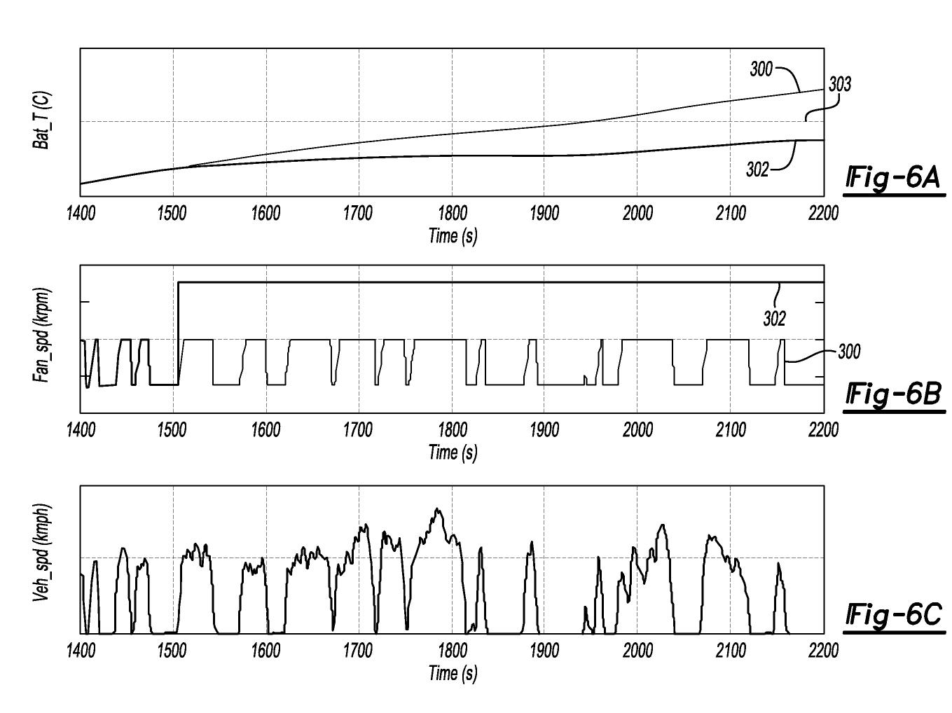

FIGS. 6A through 6C are graphs illustrating a comparison between two thermal management control system strategies utilizing an air cooling system having a fan over a given period of time as represented by an x-axis. A first control system 300 directs operation of the fan speed based on vehicle speed. A second control system 302 directs operation of the fan speed based on a battery pack heat generation rate and predicted battery pack temperature as described above and shown in FIGS. 4 and 5. In FIG. 6A, a y-axis represents a battery pack temperature and a predefined high bang threshold may be represented by a line 303. In FIG. 6B, a y-axis represents a fan speed. In FIG. 6C, a y-axis represents a vehicle speed common for both the control system 300 and the control system 302. Referring now to the time period beginning at 1500 seconds and moving forward in FIG. 6B, the control system 302 is shown setting the fan speed to a constant speed which does not change according to vehicle speed as shown in FIG. 6C. As such, the control system 302 may manage the battery pack temperature such that battery pack temperature remains below the predefined high bang threshold while the battery pack temperature for the control system 300 is shown exceeding the predefined high bang threshold which may as a result, trigger a shut off of the battery pack.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for cooling a traction battery system of a vehicle comprising:
in response to a predicted battery pack temperature being greater than a predefined threshold, adjusting by a controller a speed of a battery cooling fan according to a battery heat generation rate such that for a given battery heat generation rate, the speed remains generally constant as a speed of the vehicle changes and a stop/start state of an engine changes.

2. The method of claim 1 further comprising, in response to the predicted battery pack temperature being less than another predefined threshold, adjusting the speed of the battery cooling fan according to the speed of the vehicle or a stop/start state of the engine.

3. The method of claim 2, wherein the predefined threshold and another predefined threshold are equal to one another.

4. The method of claim 1 further comprising, in response to the predicted battery pack temperature being less than another predefined threshold, adjusting the speed of the battery cooling fan according to the battery heat generation rate, the speed of the vehicle, and the stop/start state of the engine.

5. The method of claim 1, wherein the predefined threshold is a predefined temperature of the battery pack in which the battery pack is configured to cease operation or reduce power when reached.

6. The method of claim 1, wherein the heat generation rate is based on a difference between electric energy delivered to and removed from the system and a change in internal electric energy of the system.

7. The method of claim 1, wherein the speed of the battery cooling fan is adjusted such that a temperature of the battery pack is maintained below the predefined threshold.

8. A vehicle comprising:
a motor;
a traction battery pack configured to supply power to the motor;
a fan configured to direct air flow to the traction battery pack; and
at least one controller programmed to, in order to maintain a temperature of the traction battery pack below a predefined pack cutoff temperature,
set a speed of the fan based on a heat generation rate of the traction battery pack, in response to a predicted temperature of the traction battery pack exceeding a first predefined value, such that for a given heat generation rate, the speed remains generally constant as a speed of the vehicle changes and an on/off state of the motor changes, and
set the speed of the fan based on the speed of the vehicle or the on/off state of the motor in response to the predicted temperature falling below a second predefined value.

9. The vehicle of claim 8, wherein the first predefined value is a temperature equal to or less than the predefined pack cutoff temperature.

10. The vehicle of claim 8, wherein the first and second predefined values are equal to one another.

11. The vehicle of claim 8, wherein the first predefined value is greater than the second predefined value.

12. The vehicle of claim 8, wherein in response to the predicted temperature falling below the second predefined value, the speed of the fan is set further based on the heat generation of the traction battery pack.

13. The vehicle of claim 8, wherein the heat generation rate is based on a difference between energy delivered to and removed from the traction battery pack, an amount of heat leaving the traction battery pack, and a change in internal energy of the traction battery pack.

14. A vehicle traction battery system comprising:
a battery pack;
a fan configured to direct air flow to the pack; and
at least one controller programmed to, in response to a predicted pack temperature being greater than a first predefined temperature, direct the fan to operate at a predefined generally constant speed that does not change with vehicle speed or engine on/off state until the predicted battery pack temperature falls below a second predefined temperature.

15. The system of claim 14, wherein the predicted pack temperature is based on a heat generation rate of the pack.

16. The system of claim 15, wherein the heat generation rate is based on a heat capacity of the pack and a change in temperature of the pack over time.

17. The system of claim 15, wherein the heat generation rate is based on a battery pack voltage, a battery pack open circuit voltage, a battery pack current flow, a battery pack heat transfer coefficient, a battery pack temperature, and a temperature of air within a battery pack fan inlet duct.

18. The system of claim 14, wherein the first predefined temperature is a temperature at which the pack is configured to cease operating when reached.

19. The system of claim 14, wherein the first predefined temperature is a temperature at which the pack is configured to reduce power input/output.
